(19) United States
(12) Patent Application Publication
(10) Pub. No.: US 2010/0032483 A1
(43) Pub. Date: Feb. 11, 2010

(54) Digital Polling System and Method

(75) Inventors: Charbel Aoun, London (GB); Gabriel Bellenger, London (GB)

Correspondence Address: Vedder Price PC, 222 NORTH LASALLE STREET, CHICAGO, IL, 60601, US

(73) Assignee: ACCENTURE GLOBAL SERVICES GMBH, Schaffhausen (CH)

(21) Appl. No.: 12/439,984

(22) PCT Filed: Sep. 4, 2007
(86) PCT No.: PCT/GB07/03330

§ 371 Date: Jun. 12, 2009

(30) Foreign Application Priority Data
Sep. 4, 2006 (GB) 0617379.3

(51) Int. Cl. G07C 13/00

(52) U.S. Cl. 235/386

(57) ABSTRACT

A method and system for digitally capturing polling data for one or more candidate options is provided wherein a voter is provided with a physical ballot form (30), and ballot data is digitally captured by analysing a digital record to determine the location of one or more marks on the form, such as to associate them with corresponding one or more selected candidate options. The data may be captured using a digital pen (2) as the marks are made. A method and system for analysing such ballot data is also disclosed.

### FIELD

The present disclosure relates to a system and method for digitally capturing polling data.

### DESCRIPTION OF THE RELATED ART

Digital, computerised polling machines have been used increasingly over the past few years, for example in the United States of America. Typically, these polling systems include a terminal displaying a choice of candidates on a screen and the voter can interact with the machine, for example via a touch screen, to select one or more of the candidate options. Throughout this description, it is understood that the phrase “candidate option” refers to a person standing for election, a political party, other entities standing for election or an option like “yes” or “no” in a plebiscite.

In practice, numerous problems have been encountered with the use of digital voting machines of the kind described above. For example, voters have found it difficult to interact with the machines and there have been reports of spoilt ballots entries where the machines have not registered correctly a voter's choice. This problem is aggravated by the fact that the above described machines do not provide a direct paper trail of the voter's choice, even though a print-out of what the machine recognises as the input may be produced.

The above mentioned problems are not present when traditional paper ballots are used for the voting process as the public is well used to the notion of selecting a candidate on a ballot paper and a direct paper trail is created as soon as the candidate marks the ballot paper with his choice so that a recount is possible at all times. However, traditional paper ballots require large amounts of administrative back-up for counting, verifying etc. It is this administrative problem which has led to the development of digital polling machines of the kind described above.

Accordingly, it would be desirable to develop a polling system which combines the advantages of the digital polling machine and traditional paper ballots while avoiding the respective drawbacks. In particular, it would be desirable to develop a system which is easy to use for the voter, has minimal administrative overhead in vote counting and in which the election results are verifiable by a paper audit trail.

### SUMMARY

In a first embodiment, there is provided a method of digitally capturing a vote for one or more candidate options. The method includes providing a voter with a physical ballot form such as a ballot paper listing a plurality of candidate options, which is to be marked using a marking or writing implement. One or more physical marks made on the form by the user are digitally captured to derive a digital record which is analysable to determine the position of the one or more marks on the form such as to associate them with corresponding one or more selected candidate options.

In embodiments, the marking implement may be used to capture the mark in real time as it is made, for example by recording the position of the marking implement on the form as the mark is made. This may be achieved by recording a sequence of images of a pattern on the form, which pattern is indicative of position on the form.

In embodiments, the capture may be terminated by placing the marking implement in a position, thereby terminating the transmission of the digital record for analysis. The implement may be placed in position in a cradle by the user, for example when the cradle is provided in a voting booth. Alternatively, the pen may be handed by the user to an election official who may scan or write a unique indicium on the form using the implement identifying the ballot form and linking the form to the voter, possibly using the marking implement for scanning or using an integrated device. Data transmission may be by wireless connection.

The marking implement may store a plurality of records inside it, and transmit them in a single transmission to a computer system for analysing the records to derive a plurality of votes, for example votes may be recorded during the day inside the pen, which may be taken to a central office at the end of the day for downloading of the recorded votes.

In a second embodiment, there is provided a method of counting votes captured by a method as described above. In a third embodiment, there is provided a system implementing such a method.

The digital records may be analysable to automatically detect spoilt ballots, for example, where a ballot form has tick boxes against candidates names, a spoilt ballot could be detected by testing whether a mark is present on the form outside any of the boxes by more than a pre-determined amount or if there is more than a pre-determined number of boxes marked. If a spoilt ballot paper is detected an election official may be alerted to deal with the situation, for example, an identification of the corresponding physical form may be provided or the physical ballot form may be reproduced digitally by superimposing the record on an electronic version of the physical ballot form or both.

According to a fourth embodiment, there is provided a system for digitally capturing a vote for one or more candidate options from a physical ballot form including a detector for detecting physical marks made by a user on the physical ballot form using a marking implement. The system also includes an analyser arranged to analyse a digital record captured using the detector to determine the position of the one or more marks on the form such as to associate them with corresponding one or more selected candidate options.

The detector may be mounted on the marking implement and may be arranged to record the position of the marking implement on the paper as the mark is made, for example by recording a sequence of images of a pattern on the form, the pattern being indicative of the position on the form.

The system may include a holder for accepting the writing element. The holder may include transmission means for transmitting a captured record. The implement may include a wireless transmitter for transmitting a captured record to a data storage device.

For example, the holder may be secured inside a polling booth, and, in particular, the pen may be securely attached to the holder to prevent theft.

The system may further be adapted to implement the various method steps described above.

In other embodiments, there is provided a ballot paper, imprinted with a pattern indicative of its position on the ballot paper. Additionally, the pattern may uniquely identify each ballot paper or the ballot paper may be provided with an additional indicia uniquely identifying the ballot paper.

### BRIEF DESCRIPTION OF THE DRAWINGS

Embodiments are now described, by way of example only, with reference to the accompanying figures in which:

FIG. 1 schematically depicts a digital voting system in accordance with the embodiment;

FIG. 2 schematically depicts a marking implement used in the embodiment;

FIG. 3, schematically depicts a voting process; and

FIGS. 4 and 5 schematically depict ballot forms; and

FIG. 6, schematically depicts a method of analysing ballots.

### DETAILED DESCRIPTION OF PARTICULAR EMBODIMENTS

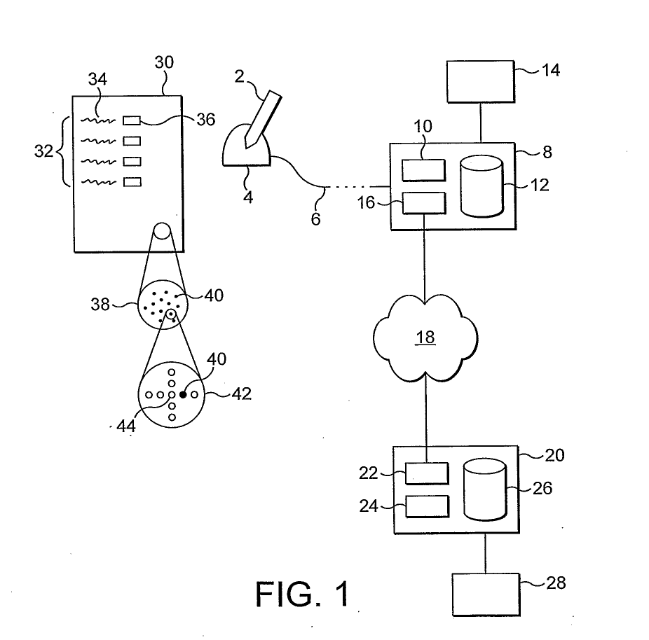

With reference to FIG. 1, a digital polling system according to an embodiment may include a digital pen or marking implement 2, which may be replaceably held in a cradle 4 arranged to charge the pen 2 electrically and to transfer data to and from it. The cradle 4 may be connected via a data link 6, to a computer 8, for example a laptop computer, which includes a processing unit 10, storage 12, input and output devices 14 and a network adaptor 16. The network adaptor 16 may connect via a network such as an inter- or intranet 18 to a server computer 20 via a network adaptor 22. The server computer 20 may have a processing unit 24, storage 26 and input and output devices 28. Data received from the cradle 4 may be stored locally on storage 12 and may be transmitted over network 18 to be stored in storage 26 for further processing. Data from multiple polls may be stored in storage 12 and transmitted via network 18 as a batch or data may be transmitted as it is received.

Alternatively, computer 8, or an external storage device associated with it, may be taken to a central location for uploading directly into server computer 20.

In one example embodiment, the pen 2 in the cradle 4 may be provided in a polling booth and a voter may initiate a voting transaction by removing the pen from the cradle and terminate the voting transaction by replacing it, initiating data transfer. The pen may be physically secured to the cradle which may in turn be physically secured to the voting booth to prevent theft. In an alternative embodiment, the cradle and pen may be under the control of a polling official, who hands out the pen to the voter and receives it back together with the ballot form. In this case, multiple pens may be associated with the same cradle. The voting process is described in more detail below.

The pen 2 may be arranged to detect the position of marks made by a voter on a ballot paper 30 which may contain a list 32 of text 34, identifying candidate options, and corresponding check boxes 36, or other regions for marking to identify a selected candidate. As indicated schematically in magnified view 38, the paper may contain a pattern of dots 40 which may be barely visible to the eye but can be detected by the pen 2. The further magnified view 42 schematically indicates that the pattern of dots 40 may encode positions on the paper by the displacement of the dots 40 with respect to a nominal position 44.

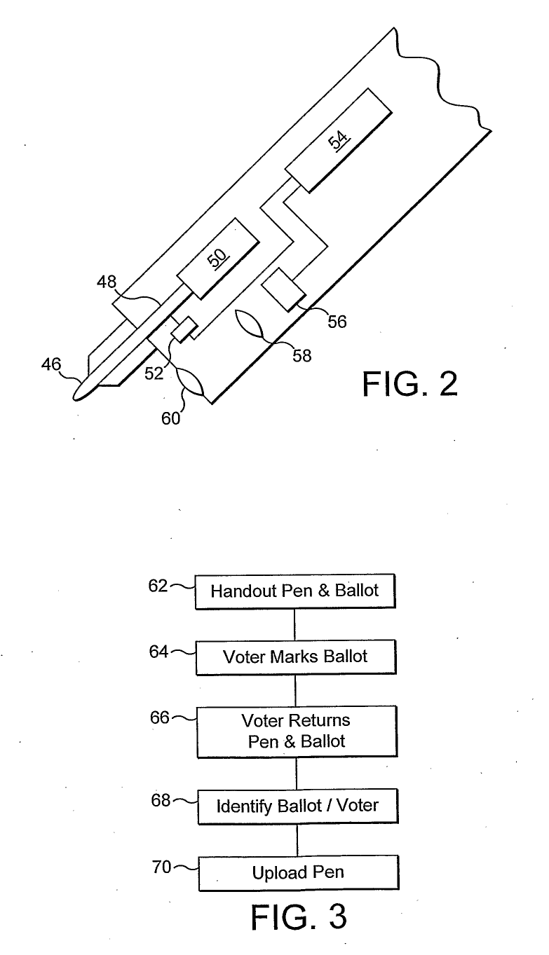

A portion of the pen 2 is schematically represented in FIG. 2. The pen may have a writing tip 46 from marking paper which may be connected by a conduit 48 to an ink reservoir 50. A force sensor 52 may be provided to detect when the tip 46 is pressed on paper to activate the position recording as the pen marks the paper by transmitting this information to a central processing unit 54.

An imaging device 56, for example CCD (Charge Coupled Device), may be arranged to image the pattern of dots 40 on the paper through a lens 58 and aperture 60. The central processor 54 may be arranged to use a sequence of images of the pattern in conjunction with knowledge of the geometry of the pen to derive a sequence of positions of the tip of the pen on the paper where the paper has been marked (as detected by force sensor 52). Other components of the pen, such as a battery, a local storage device, a data exchange device or a user interface may also be present in the pen but are not depicted.

The above-referenced pen and paper technology is available from Anoto AB, and its licensees. Further details can be found on www.anoto.com or in the “Anoto Development Guide (General)” document available from Anoto Public Reference Documentation (http://partner.anoto.com/cldoc/aop19.htm) which are incorporated herein by reference. A number of digital pens are commercially available but a particularly suitable version would be the Logitech® io™ 2 BT pen in conjunction with firmware version 44.20 or more recent which are incorporated herein by reference. This pen enables scanning of barcodes in addition to detecting the marks on the paper and allows connection both via a USB cradle or a Bluetooth wireless connection. Depending on the specific implementation, other digital pens may be equally suitable.

With reference to FIG. 3, an example polling transaction is now described. At step 62, a poll official hands out a digital pen and a ballot paper to a voter, which the voter then takes to a polling booth and marks with his choice of candidate option or options at step 64.

At step 66, the voter returns the pen and ballot paper to the poll official, who checks the identity of the voter and links the physical ballot paper and its digital records stored in the pen with the voter identification, as described in detail below.

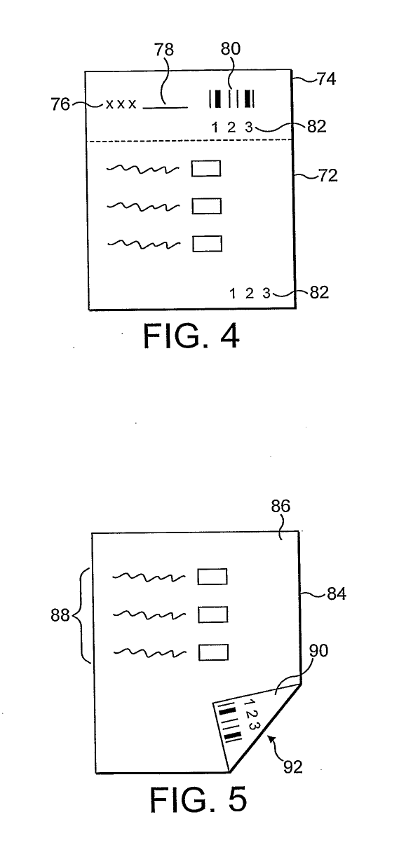

In some countries, for example the United Kingdom, it is a requirement that a particular ballot paper can be linked to the voter who filled it in, if, and only if a Court Order is issued to that effect. Otherwise, confidentiality of the voters is to be ensured. To this effect, the ballot paper may be set out as depicted schematically in FIG. 4. In addition to the ballot 72, the ballot paper may include a tear-off portion 74, which may have a field 76 for printing the voter's name, and a field 78 for a signature, a barcode 80 and an identification number 82. The identification number 82 may also be printed on the ballot 72. In completing the ballot, the voter may print his name at 76 and sign at 78, in addition to marking the ballot as described above.

Once finished voting, the voter may detach the tear-off portion 74 from the ballot 72 and fold the ballot and/or place it in an envelope to ensure confidentiality. He then returns the portion 74, folded ballot 72 and the digital pen to the voting officer, who after verifying the voters identity, scans the barcode 80 with the digital pen, associating the digital record of the vote to the physical ballot paper via the identification number 82, which may be encoded in the barcode. It is understood that the scanning of a barcode is optional and that other means of entering indicia identifying the ballot paper are equally possible, for example rewriting the indicia with the pen on the ballot paper and typing in the same identification number into the computer 8 to link the physical ballot with the voter's name for Court Order auditing purposes. The voting transaction may then be terminated by uploading the data from the pen to the computer 8 at step 70 and erasing the data from inside the pen, which is then ready for the next voting transaction.

Alternatively, where the pen is used to scan barcode 80 (or another element of the ballot paper, such as a New Page/New Book pidget, to indicate the end of the voting transaction), the pen may immediately be reused to record a subsequent polling transaction until the limit of the pen's memory is reached. In this case, the pen may be connected at the end of a predefined period, for example a day, at a central election office, directly to the server computer 20 and thus eliminate the need for the local computer 8 at the polling station.

A further possibility is for the poll officer to use the pen to record the name and the signature of the voter on the tear-off portion (which may remain in a poll paper book) so that the transmitted pen strokes have both the voting information as well as the identity information from the tear-off portion. If a court order requires identification of the voter, the digital data from the tear-off portion can be used for this purpose, reconstructing a complete digital image at the back end system to verify that the unique identifier or barcode and the recorded name correspond to the same voter.

In the described embodiment a direct digital image of the vote is not present in the pen, which records a sequence of time stamped positions representing the marks on the ballot paper. Thus, confidentiality of the vote may be ensured by encrypting the data downloaded from the pen and only enabling the displacing of a visual reconstruction or other form of output identifying a voter's choice to an operator only after entering of suitable security credentials, such as a login and password, USB key or a smartcard. Similarly, the tear-off portions 74 may be kept confidential or destroyed at the end of the poll.

If biometric signature data is available as part of a biometric passport or identification card issued to citizens, the identification process may be simplified further by using the digital pen to record the voter's signature such that, upon download of the data, computer 8 may retrieve the voter's identity from a corresponding database and display it to the voting officer for the purpose of verifying the voter's name stated on the tear-off portion. In addition or alternatively, the retrieved identity may be stored in a secure area on central server 20 to satisfy legal requirements of enabling identification of the voter in response to a Court Order.

In jurisdictions were identification of the voter is not required (or prohibited) step 68 can be simplified as only identification of the ballot paper to link it to the corresponding digital record may be required. A ballot paper which may be used in such a case is depicted schematically in FIG. 5. The ballot paper 84 has a first side 86 which, in addition to the dot pattern enabling position detection, has the list of candidate options 88. On a second side 90 indicia 92 identifying the ballot paper are provided such that it remains visible when the ballot paper is folded to hide the voter's choice. Indicia may include a barcode (to be scanned using the pen), an identifying number and/or any other means of identification of the machine or human readable type. The indicia 92 may alternatively be provided on the first side 86 and other means of ensuring confidentiality such as an envelope with an appropriate cut-out may be used. The barcode can then be scanned by the poll officer using the pen.

In an alternative implementation, the pen is not handed out to a voter by a polling official, but may be provided inside a voting booth, as described above. In this alternative implementation, the task of the poll officer are the same as in a conventional paper ballot, in essence handing out ballots, ensuring they are correctly posted in a ballot box and possibly identifying the voter. The marked ballot paper may be associated with the digital record inside the pen by means of a unique pattern of dots on each individual ballot paper. In this case, the voter's experience may be entirely equivalent to a conventional paper ballot. The voting transaction is started by removing the pen from its cradle, the ballot form is marked in the conventional way and the transaction is terminated by replacing the pen in the cradle.

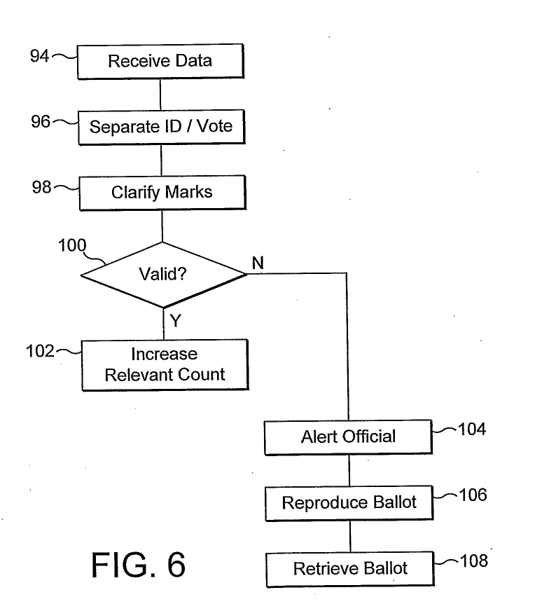

The marking of the ballot from may be monitored on-line as the form is marked to alert the voter if he or she is about to produce or has produced a spoilt ballot form. Techniques for detecting spoilt ballot forms are described below in the context of processing data from the pen for vote counting with reference to decision node 100 in FIG. 6. The monitoring may be carried out using any processing capacity within the pen or by a separate computer in, for example, wireless communication with the pen. The voter may be alerted by a warning light or screen display that a spoilt ballot would result from the marks made and could be requested to mark a fresh copy of the ballot form.

In order to avoid the cost of printing unique pattern such as a unique pattern of dots on each ballot paper, each ballot paper may be provided with unique indicia, for example a barcode, and the user may be instructed to scan the indicium by using the digital pen. Compliance can be ensured by providing a warning sound and/or light and/or displaying a warning message on a computer screen if the voter replaces the pen in the cradle without scanning the indicium. A poll officer may provide guidance if required. The unique barcode can be either pre-printed on each single ballot paper or externally available via the list of authorized voters which then uniquely identify a voter.

In each case, a mapping/link may need to be made and recorded into the back end system between the physical ballot and the voter, as described above.

Once the data has been uploaded to the central server 8, it is processed further to count the votes against each candidate (although the processing may be distributed over the entire system in any suitable manner).

With reference to FIG. 6, an example analysis of the data generated by the pen is now described.

At step 94, the data is received by an application service handler and confidential information such as the voter's identity is separated from the data representing the pen marks corresponding to the vote (and securely stored) at step 96. The positional data representing the vote may be classified at step 98, for example into marks inside or outside the tick boxes and linking each mark to a corresponding tick box if inside a tick box.

At decision node 100, it is detected whether the ballot is spoilt or not, that is, depending on regulations, whether more than the necessary or predetermined number of tick boxes have been ticked, whether any marks are present outside any of the tick boxes or whether any protrude from the tick boxes by more than a predetermined amount. If the ballot is determined to be valid, the vote count for the relevant candidate or candidates is increased at step 102. If, on the other hand, the ballot is detected to be invalid, an poll official may be alerted at step 104.

This may occur as and when a spoilt ballot is detected or a spoilt ballot report may be produced once or periodically to bring the spoilt ballots to the attention of the poll official. In order to allow the poll official to judge the validity of the ballot, an electronic reproduction of the ballot paper with the recorded mark superimposed may be presented to the election official for visual inspection (step 106). If necessary, the paper ballot form may be retrieved using a ballot form identifier stored together with the electronic records of the marks to facilitate retrieval (step 108). The identifier may include an identification of the polling station where the ballot was filled in, which may be derived from a unique identifier present in each digital pen and transmitted with the position data. Identification may also include the identifier of the original ballot paper, derived and transmitted by any of the methods described above.

It is understood that a number of variations and modifications of the system and methods described above will be apparent to the skilled person. For example rather than transmitting data from the pen using a USB cradle as described above, transmission may be by a Bluetooth link to a mobile phone and subsequent GPRS or 3G data connection or any other suitable method. Where appropriate, the sequence of steps as described above may be varied, for example, the identification of the voter may be carried out at the outset as the ballot is handed to the voter. The barcode can be replaced by any means for unique identification (e.g. written identification number).

Alternative means of capturing marks made by the voter on the ballot paper are equally possible. For example, a polling station may be provided with a modified ballot box in to which ballots are posted through a slit coupled to a scanner such that each ballot is scanned automatically as it is put in the ballot box. For identification purposes, the ballot may include machine readable indicia, enabling the digital copy to be linked to the physical copy put in the ballot box. If linking the ballot paper to a voter's name is required, this can be achieved as for conventional ballot papers, for example when the ballot paper is handed to the voter.

The above applications represent illustrative examples and the disclosed techniques can be employed in other polling applications, such as seeking customer feedback on product or service preferences. Further, the various aspects and disclosed techniques (including systems and processes) can be modified, combined in whole or in part with each other, supplemented, or deleted to produce additional implementations.

The systems and techniques described here can be implemented in digital electronic circuitry, or in computer hardware, firmware, software, or in combinations of them. The systems and techniques described here can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the systems and techniques described here can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The typical elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks. The processor and the memory can be supplemented by, or incorporated in special purpose logic circuitry.

To provide for interaction with a user, the systems and techniques described here can be implemented on a computer having a display device such as a CRT (cathode ray tube) or LCD (liquid crystal display) monitor for displaying information to the user and a keyboard and a pointing device such as a mouse or a trackball by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input.

The systems and techniques described here can be implemented in a computing system that includes a back-end component, e.g., as a data server, or that includes a middleware component, e.g., an application server, or that includes a front-end component, e.g., a client computer having a graphical user interface or an Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

The present invention has been described herein with reference to specific particular embodiments thereof. It will be apparent to those skilled in the art that a person understanding this invention may conceive of changes or other embodiments or variations, which utilize the principles of this invention without departing from the broader spirit and scope of the invention as set forth in the appended claims. All are considered within the sphere, spirit, and scope of the invention.

1. A method of digitally capturing polling data for one or more candidate options wherein a voter is provided with a physical ballot form, the form listing a plurality of candidate options to be marked using a marking implement, the method including;
digitally capturing data corresponding to one or more marks made on the form by the voter to derive a digital record of the mark or marks; and
analysing the digital record to determine the location of the one or more marks on the form, such as to associate them with corresponding one or more selected candidate options;
wherein the marking implement is used to digitally capture data corresponding to the mark and placing the marking implement in a holder terminates the capturing and initiates a transfer of poll data to a storage device.

2. (canceled)

3. A method as claimed in claim 1 in which the marking implement is used to digitally capture the mark in real-time.

4. A method as claimed in claim 1 in which the capturing includes recording a position of the marking implement on the paper as the mark is made.

5. A method as claimed in claim 1 in which the capturing includes recording an image of a pattern on the form, which pattern is indicative of a location on the form.

6. (canceled)

7. (canceled)

8. A method as claimed in claim 1 including wirelessly transferring polling data to the storage device.

9. A method as claimed in claim 1 including storing a plurality of records inside the marking implement and transmitting the plurality of records in a single transmission to a storage device for analysis in determining a poll result.

10. A method as claimed in claim 1 including associating the digital record with the form.

11. A method as claimed in claim 10 in which the associating includes scanning a machine readable indicium.

12. A method as claimed in claim 11 in which the indicium is a position encoding pattern.

13. A method as claimed in claim 12 in which the indicium is scanned by the voter.

14. A method as claimed in claim 10 in which the associating includes a poll official physically marking the ballot form and digitally capturing the physical marking by the poll official.

15. A method as claimed in claim 14 in which the capturing is done by using a marking implement.

16. A method as claimed in claim 1 including associating the voter with the digital record.

17. A method as claimed in claim 16 including associating the voter with the physical ballot form.

18. A method as claimed in claim 16 including digitally capturing the voters signature using the marking implement.

19. A method as claimed in claim 1 including analysing the captured data while it is being captured to detect marks associated with a spoilt ballot form and, if such a mark is detected, alerting the voter.

20. A method of counting votes for a candidate option comprising using polling data captured by a method as claimed in claim 1.

21. A method as claimed in claim 20, including digitally analysing the record to detect spoilt ballot forms.

22. A method as claimed in claim 21 in which the ballot form has voter input region, and the detecting of spoilt ballot forms includes detecting marks outside any of the input regions or marks extending from an input region by more than a pre-determined threshold or the presence of an unacceptable number of marks.

23. A method as claimed in claim 21 in which a poll official is alerted if a spoilt ballot is detected.

24. A method as claimed in claim 23 in which alerting the poll official includes displaying a means for identifying the ballot form to enable its retrieval.

25. A method as claimed in claim 23 in which a blank electronic copy of the ballot form is displayed to the poll official with a representation of the digital record superimposed.

26. A system for digitally capturing polling data for one or more candidate options from a physical ballot form including a detector for detecting physical marks made by a user on the form using a marking implement; an analyser arranged to analyse a digital record captured using the detector to determine the position of one or more marks on the form such as to associate them with one or more selected candidate options; wherein the detector is mounted on the marking implement; wherein the system includes a holder for accepting the marking implement and is arranged to terminate the digital record when the marking implement is placed in the holder; and wherein the holder is arranged to initiate transfer of poll data when the marking implement is placed in the holder.

27. (canceled)

28. A system as claimed in claim 26 in which the detector is arranged to record the position of the marking implement on the paper as the mark is made.

29. A system as claimed in claim 26 in which the detector is arranged to record a sequence of images of a pattern on the form, the pattern being indicative of location on the form.

30. (canceled)

31. (canceled)

32. A system as claimed in claim 26 in which the marking implement includes a wireless transmitter for transferring poll data to a storage device.

33. A system as claimed in claim 26 in which the marking implement includes an internal storage for storing a plurality of records and is arranged to transmit the plurality of records in a single transmission to a storage device.

34. A system as claimed in claim 26 which is arranged to associate the digital record with the form.

35. A system as claimed in claim 34 which is arranged to be operable to scan a machine readable indicium such as to associate the digital record with the form.

36. A system as claimed in claim 35 in which the indicium is the pattern.

37. A system as claimed in claim 34 in which the marking implement is digitally arranged to capture a physical mark made by a poll official to associate the digital record with the form.

38. A system as claimed in claim 26 which is arranged to associate the voter with the digital record.

39. A system as claimed in claim 38 arranged to associate the voter with the form.

40. A system as claimed in claim 38 which is arranged to digitally capture the voters signature using the marking implement.

41. A system as claimed in claim 26 including an on-line analyser arranged to analyse the captured data while it is being captured to detect marks associated with a spoilt ballot form and an alert arrangement operatively connected to the on-line analyser and arranged to alert the user if such a mark is detected.

42. (canceled)

43. (canceled)

44. (canceled)

45. (canceled)

46. (canceled)

47. (canceled)

48. (canceled)

49. (canceled)

50. A computer readable medium containing computer executable instructions for implementing a method as claimed in claim 1.
